(19) United States
(12) Patent Application Publication
(10) Pub. No.: US 2004/0002579 A1
(43) Pub. Date: Jan. 1, 2004

(54) Process for the preparation of polyisocyanates of the diphenylmethane group having a reduced color value

(76) Inventors: Torsten Hagen, Essen (DE); Friedhelm Kamper, Krefeld (DE); Daniel Koch, Duisburg (DE); Heinz-Herbert Muller, Krefeld (DE)

Correspondence Address: BAYER POLYMERS LLC, 100 BAYER ROAD, PITTSBURGH, PA, 15205, US

(21) Appl. No.: 10/606,399

(22) Filed: Jun. 23, 2003

(30) Foreign Application Priority Data
Jun. 27, 2002 (DE) 10228734.1

(51) Int. Cl. C08G 12/04; C08G 12/06

(52) U.S. Cl. 528/266; 528/269

(57) ABSTRACT

The invention relates to a process for the preparation of polyamines of the diphenylmethane series, comprising

a) reacting aniline and formaldehyde in the presence of an acid catalyst to form polyamines, and

b) neutralizing the reaction mixture formed in a) with a base,

wherein at least one alcohol is present during and/or after the neutralization step. The molar ratio of the alcohol to the formaldehyde is at least 0.02:1.

In addition, the present invention relates to a process for the preparation of polyisocyanates of the diphenylmethane series, according to the process as described above, additionally comprising:

c) phosgenating the resultant polyamines into the corresponding polyisocyanates of the diphenylmethane series.

### BACKGROUND OF THE INVENTION

The present invention relates to a process for the preparation of polyamines of the diphenylmethane series and to a process for the preparation of polyisocyanates of the diphenylmethane series having reduced color values. In the process of preparing the polyisocyanates, the resultant polyamines are further phosgenated to form the corresponding polyisocyanates of the diphenylmethane series.

Polyisocyanates of the diphenylmethane series are to be understood as being isocyanates and mixtures of isocyanates of the following type:

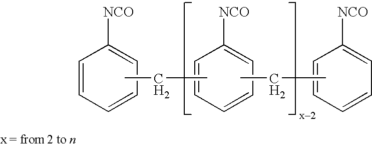

By analogy, polyamines of the diphenylmethane group are to be understood as being compounds and mixtures of compounds of the following type:

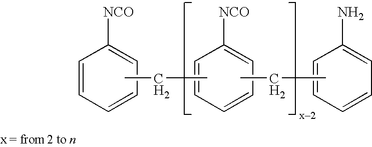

The large-scale preparation of isocyanates by reaction of amines with phosgene in solvents is known and is described in detail in the literature (Ullmanns Enzyklopädie der technischen Chemie, 4th Edition, Volume 13, page 347-357, Verlag Chemie GmbH, Weinheim, 1977). On the basis of that process, polyisocyanate mixtures are obtained which are used as polyisocyanate components in the production of polyurethane foams and other polyurethane plastics produced by the polyaddition process.

It is generally known that undesirable colorants or color-giving components are also formed in that process, and these are also retained during further processing of the polyisocyanates to polyurethane foams or other polyurethane plastics. Although the intrinsic color of the polyisocyanate polyaddition products does not adversely affect their mechanical properties, substantially colorless products are desired by the consumer. A measure of the change in color of the polyisocyanate is the extinction at various wavelengths.

Accordingly, it has for a relatively long time been the aim of many experiments and works, which are described in the literature, to reduce the color values of polyisocyanates of the diphenylmethane series. For example, DE-A1-4208359 describes the treatment of such isocyanates with hydrogen in the presence of support catalysts. DE-A1-4232769 describes the addition of amines, ureas and antioxidants to the isocyanate. DE-A1-19815055 describes improving the color of polyisocyanates of the diphenylmethane group by irradiation with light over a prolonged period of time. DE-A1-19804915 describes the brightening of polyisocyanates of the diphenylmethane series by the complicated addition, stepwise in terms of time and temperature, of formaldehyde at the polyamine stage, the polyamine then being converted into the desired isocyanate by phosgenation.

A disadvantage of all those procedures is that they are technically complex and/or not very efficient.

### SUMMARY OF THE INVENTION

The object of the present invention is, therefore, to provide a process which is technically simple and reliable and by means of which polyisocyanates of the diphenylmethane series having low color values can be prepared. A further object of the present invention is to provide a simple process for the preparation of polyamines of the diphenylmethane series, from which the corresponding polyisocyanates of the diphenylmethane series having low color values can be prepared by phosgenation of the polyamines.

The object is achieved according to the invention by a process for the preparation of polyamines of the diphenylmethane series, comprising:

a) reacting aniline and formaldehyde in the presence of an acid catalyst to form polyamines, and

b) neutralising the reaction mixture from a) with a base,

wherein at least one alcohol is present during and/or after the neutralisation step, with the molar ratio of the alcohol to the formaldehyde being at least 0.02:1.

In accordance with the present invention, the alcohol may be added at a point prior to the neutralisation, during the neutralisation, or after the neutralisation of the reaction mixture. In one embodiment of the invention, after neutralisation, the phases are separated, and the alcohol and an additional quantity of a base are added to the organic phase.

The object is also achieved according to the invention by a process for the preparation of polyisocyanates of the diphenylmethane series, comprising

a) reacting aniline and formaldehyde in the presence of an acid catalyst to form polyamines,

b) neutralising the reaction mixture from a) with a base, and

c) phosgenating the resultant polyamines into the corresponding polyisocyanates,

wherein at least one alcohol is present during and/or after the neutralisation step, with the molar ratio of the alcohol to the formaldehyde being at least 0.02:1.

In accordance with this aspect of the present invention, the alcohol may be added at a point prior to the neutralisation, during the neutralisation, or after the neutralisation of the reaction mixture. In one embodiment of the invention, after neutralisation, the phases are separated, and the alcohol and an additional quantity of a base are added to the organic phase.

The process according to the invention can be carried out either continuously or discontinuously.

Polyisocyanates with low color values can be produced by the process according to the invention. Color value here is understood to mean the measured absorbance of a solution of polyisocyanate in monochlorobenzene, containing 2 wt. % polyisocyanate, in a layer thickness of 10 mm and at room temperature, against monochlorobenzene at defined wavelengths.

### DETAILED DESCRIPTION OF THE INVENTION

The polyamine or polyamine mixture of the diphenylmethane series which is prepared by the process according to the present invention is obtained by the condensation reaction of aniline and formaldehyde in the presence of an acid catalyst (H. J. Twitchett, Chem. Soc. Rev. 3(2), 209 (1974), M. V. Moore in: Kirk-Othmer Encycl. Chem. Technol., 3rd Ed., New York, 2, 338-348 (1978)). It is not important to the process of the present invention whether the aniline and formaldehyde are first mixed in the absence of the acid catalyst and the acid catalyst is added subsequently, or whether a mixture of aniline and acid catalyst is reacted with formaldehyde.

Suitable polyamine mixtures of the diphenylmethane series are usually obtained by the condensation reaction of aniline and formaldehyde in a molar ratio of from 20:1 to 1.6:1, preferably from 10:1 to 1.8:1, and a molar ratio of aniline and acid catalyst of from 20:1 to 1:1, preferably from 10:1 to 2:1.

Commercially, formaldehyde is generally used in the form of an aqueous solution. It is, however, also possible to use other compounds (instead of formaldehyde) that supply methylene groups, such as, for example, polyoxymethylene glycol, para-formaldehyde or trioxane.

Strong organic and, preferably, inorganic acids have proved to be suitable as acid catalysts. Examples of suitable acids include hydrochloric acid, sulfuric acid, phosphoric acid and methanesulfonic acid. Preference is given to the use of hydrochloric acid.

In a preferred embodiment of the process, the aniline and the acid catalyst are first combined. In a further step, optionally after the removal of heat, that mixture is mixed in a suitable manner with formaldehyde at temperatures of from 20° C. to 100° C., preferably from 30° C. to 80° C., and is then allowed to undergo a preliminary reaction in a suitable dwell-time apparatus. The preliminary reaction is carried out at temperatures of from 20° C. to 100° C., preferably in the temperature range from 30° C. to 80° C. Following mixing and the preliminary reaction, the temperature of the reaction mixture is brought in steps or continuously, and optionally under excess pressure, to a temperature of from 100° C. to 250° C., preferably from 100° C. to 180° C., and most preferably of from 100° C. to 160° C.

In another embodiment of the process, it is possible first to mix and hence react the aniline and the formaldehyde, in the absence of the acid catalyst, in the temperature range of from 5° C. to 130° C., preferably from 40° C. to 100° C., and most preferably from 60° C. to 85° C., which forms condensation products of aniline and formaldehyde (so-called aminal). Following the aminal formation, water present in the reaction mixture can be removed by phase separation or other suitable process steps such as, for example, by distillation. In a further process step, the condensation product is then mixed in a suitable manner with the acid catalyst and undergoes a preliminary reaction in a dwell-time apparatus at temperatures of from 20° C. to 100° C., preferably from 30° C. to 80° C. The temperature of the reaction mixture is then brought in steps or continuously, and optionally under excess pressure, to a temperature of from 100° C. to 250° C., preferably of from 100° C. to 180° C., and most preferably of from 100° C. to 160° C.

The reaction of aniline and formaldehyde in the presence of an acid catalyst to form polyamines of the diphenylmethane group can be carried out in the presence of further substances. These substances include, but are not limited to solvents, salts, and organic and inorganic acids.

For working-up of the acid reaction mixture, the reaction mixture is neutralised with a base. According to the prior art, the neutralisation is usually carried out at temperatures of, for example, from 90 to 100° C., without the addition of further substances (see H. J. Twitchett, Chem. Soc. Rev. 3(2), 223 (1974)). Suitable bases for neutralising the reaction mixture include, for example, the hydroxides of the alkali and alkaline earth elements. Aqueous NaOH is preferably used as the base.

In the process according to the present invention, the acid reaction mixture is neutralised in the presence of an alcohol; and/or an alcohol is added to the reaction mixture after it has been neutralised; and/or the aqueous phase is removed from the neutralised reaction mixture, and a base and an alcohol are added to the organic phase that remains. The purpose of the alcohol is to increase the solubility of hydroxyl ions in the organic phase. Any compounds that increase the solubility of the hydroxyl ions and hence their concentration in the organic phase are therefore suitable in principle for the process according to the invention.

In particular, suitable alcohols for the present invention include, for example, methanol, ethanol, n-propanol, isopropanol, mono- and di-ethanolamine and their N-substituted derivatives, and triethanolamine. Preference is given to the use of methanol. The positive effect of the solubilising alcohols is not limited to the use of the pure substances. It is also possible to use mixtures of alcohols in the process according to the invention.

In one embodiment of the process according to the present invention, the acid reaction mixture from the reaction of aniline and formaldehyde is neutralised with a base in the presence of an alcohol.

The neutralisation is advantageously effected by mixing the acid reaction mixture of the aniline/formaldehyde condensation with the base and the appropriate alcohol, and conveying the mixture to a dwell-time apparatus. If suitable dwell-time apparatuses are used (e.g. stirrer vessels), it is also possible for the acid condensation mixture, the base and the alcohol to be mixed directly in the dwell-time apparatus.

The addition or feeding in of the solubilising alcohol does not necessarily have to be left until the neutralisation stage. On the contrary, it is also possible to introduce the alcohol into the process with one of the starting materials (i.e. the aniline, formalin, and/or hydrochloric acid) at the start of the process. The direct feeding in of the alcohol at any desired point of the acid-catalysed reaction of aniline and formalin is also possible. It is also possible for the alcohol to be added only following the neutralisation (in a continuous process, for example, in a downstream dwell-time apparatus) and to come into contact with the neutralised reaction mixture for a sufficient dwell time. It is also possible to add the alcohol in several portions at different locations and/or at different times in the process, in each case proportionately.

The dwell time of the reaction mixture in the presence of the alcohol in the neutralisation apparatus or downstream dwell-time apparatus is preferably ≧0.1 minute, particularly preferably from 0.1 to 180 minutes, most particularly preferably from 2 to 120 minutes, most especially particularly preferably from 5 to 60 minutes. In order to prevent boiling below or at a desired temperature, it may be necessary to carry out the process step under elevated pressure.

The base used for the neutralisation is preferably employed in amounts of greater than 100%, preferably from 101 to 140%, and most preferably from 105 to 120%, of the amount stoichiometrically required for neutralisation of the acid catalyst used. The alcohol or alcohol mixture is used in a molar ratio, relative to the formaldehyde used for the condensation reaction, of at least 0.02:1, preferably from 0.025:1 to 100:1, more preferably from 0.03:1 to 50:1, most preferably from 0.04:1 to 10:1, most particularly preferably from 0.05:1 to 5:1. The effect of the neutralisation with addition of an alcohol on the MDI color is enhanced if it is ensured that the organic phase and the aqueous phase are sufficiently thoroughly mixed in the neutralisation apparatus or downstream dwell-time apparatus. This can be effected by using the methods known in the art, such as, for example, by means of static or dynamic mixers or by generating turbulence.

Following the neutralisation, the organic phase is separated from the aqueous phase in a separating vessel. If phase separation is not possible due to the use of large amounts of solubilising alcohol, phase separation can be initiated by the targeted addition of water. Alternatively, it is also possible to first remove the alcohol from the neutralised mixture by suitable methods such as, for example, distillation, and then to carry out the phase separation. The product-containing organic phase that remains after separation of the aqueous phase is subjected to further working-up steps (e.g. washing), and then freed of excess aniline and other substances present in the mixture (e.g. further solvents) by suitable methods such as, for example, distillation, extraction or crystallisation.

In an alternative embodiment of the process according to the invention, the neutralisation is carried out according to the prior art, for example at a temperature of from 90 to 100° C. Separation of the aqueous phase and the organic phase is then carried out by one of the conventional methods, for example, in a separating flask. After the phase separation, the organic phase of the neutralised reaction mixture is mixed with a base, preferably aqueous sodium hydroxide solution, in a dwell-time vessel, and an alcohol is added thereto.

The base is used in amounts of greater than 1%, preferably from 2 to 140%, especially from 5 to 120%, of the amount stoichiometrically required for the neutralisation of the acid catalyst used for the condensation reaction. The alcohol or alcohol mixture is used in a molar ratio, relative to the formaldehyde used for the condensation, of at least 0.02:1, preferably from 0.025:1 to 100:1, more preferably from 0.03:1 to 50:1, most preferably from 0.04:1 to 10:1, most particularly preferably from 0.05:1 to 5:1. Treatment of the organic phase of the neutralised reaction mixture is carried out, for example, by mixing the organic phase either with the base or with the alcohol or alcohol mixture or with both in a mixing unit and then conveying the mixture to the dwell-time apparatus (for example stirrer vessel, stirrer vessel cascade, flow pipe or recirculating reactor). If suitable dwell-time apparatuses are used, it is also possible for the organic phase to be mixed with the base and the alcohol or alcohol mixture directly in the dwell-time apparatus.

Treatment of the organic phase of the neutralised reaction mixture with the base and the alcohol or alcohol mixture is preferably carried out for a dwell time of ≧0.1 minute, preferably from 0.1 to 180 minutes, more preferably from 2 to 120 minutes, most preferably from 5 to 60 minutes. In order to prevent boiling below or at a desired temperature, it may be necessary to carry out the process step under elevated pressure.

The effect on the color of the polyisocyanates of the diphenylmethane group is enhanced if it is ensured that the organic phase and the aqueous phase are sufficiently thoroughly mixed in the dwell-time vessel. This can be effected by using the methods known in the art such as, for example, by means of static or dynamic mixers, or by generating turbulence. After treatment of the organic phase with the alcohol, which is preferably carried out in the presence of the base, further phase separation is carried out and the organic phase is conveyed to the further working-up steps. If phase separation is not possible due to the use of large quantities of solubilising alcohol, phase separation can be initiated by the targeted addition of water. It is also possible, however, to first remove the alcohol from the neutralised mixture by suitable methods such as, for example, by distillation, and then to carry out the phase separation. It is also possible to introduce the aqueous phase containing the base into the neutralisation of the acid reaction mixture from the condensation of aniline and formaldehyde, optionally after addition of water, in order to establish the desired concentration of base.

The resulting polyamine or polyamine mixture of the diphenylmethane group is reacted, in accordance with known methods, with phosgene in an inert organic solvent to form the corresponding isocyanates. The molar ratio of crude MDA (i.e diphenylmethane diamine) to phosgene is generally such that from 1 to 10 mol, and preferably from 1.3 to 4 mol, of phosgene are present in the reaction mixture per mol of NH₂ group present. For this aspect of the present invention, suitable compounds to be used as inert solvents include chlorinated aromatic hydrocarbons such as, for example, monochlorobenzene, dichlorobenzenes, trichlorobenzenes, the corresponding toluenes and xylenes, and also chloroethylbenzene. Monochlorobenzene, dichlorobenzene or mixtures of these chlorobenzenes are used preferably used as inert organic solvents. The amount of solvent is generally such that the reaction mixture has an isocyanate content of from 2 to 40 wt. %, preferably from 5 to 20 wt. %, based on the total weight of the reaction mixture. When the phosgenation is complete, the excess phosgene and the inert organic solvent or mixtures thereof are removed from the reaction mixture by distillation.

The crude MDI's prepared by the process according to the invention have a markedly reduced coloring.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

### Example 1 (Comparison Example)

1011 g of aniline and 611 g of a 32% aqueous formaldehyde solution were simultaneously added dropwise at 80° C., over the course of 20 minutes, under a covering of nitrogen, to 200 g of aniline. After the addition was completed, the mixture was stirred for 10 minutes and then phase separation was carried out at a temperature from 70 to 80° C. 300 g of the organic phase were adjusted to a temperature of 35° C. in a nitrogen atmosphere, and then the remainder of the organic phase and 373 g of 32% aqueous hydrochloric acid were added thereto at that temperature, over the course of 30 minutes. When the addition was complete, and after stirring for an additional 30 minutes at that temperature, the mixture was heated to 60° C. over a period of 10 minutes and maintained at that temperature for 30 minutes. The mixture was then heated to reflux temperature (about 105° C.) over the course of 30 minutes, and stirring was carried out for 10 hours under reflux. Then, 123 g of 50% aqueous sodium hydroxide solution and 265 ml of boiling water were added to 684 g of the acid condensation mixture so obtained. After 30 minutes' stirring under reflux (at about 105° C.), phase separation was carried out at from 80 to 90° C. and the organic phase was washed two times with 800 ml of boiling water each time. The organic phase was then freed of excess aniline under reduced pressure. 50 g of the polyamine formed by this process were dissolved in 255 ml of chlorobenzene, heated to 55° C. and added over the course of 10 s, with intensive stirring, to a solution, adjusted to a temperature of 0° C., of 105 g of phosgene in 310 ml of chlorobenzene. While passing phosgene through, the suspension was heated to 100° C. over the course of 45 minutes and then to reflux temperature over a period of 10 minutes. After a further 10 minutes at that temperature, the solvent was distilled off under reduced pressure to a bottom temperature of 100° C. The crude isocyanate was then heated in a distillation apparatus at a pressure of from 4 to 6 mbar, by means of a heating bath heated to 260° C., until the first product passed over, and it was then cooled to room temperature over the course of 5 minutes. 1.0 g of the isocyanate so obtained was dissolved in chlorobenzene and diluted to 50 ml with chlorobenzene. The solution so obtained had an extinction value of 0.198 relative to chlorobenzene at 430 nm.

### Example 2 (According to the Invention)

An acid condensation mixture was prepared according to the procedure described in Example 1 from 838 g of aniline, 420 g of a 32% aqueous formaldehyde solution and 256 g of 32% hydrochloric acid. 74 g of 32% aqueous sodium hydroxide solution and 74 g of methanol were added to 247 g of that acid condensation mixture, and stirring was carried out for 30 minutes at 105° C. After cooling to 60° C., 700 ml of water were added to the reaction mixture and, after phase separation, as described in Example 1, the organic phase was washed with water, and freed of aniline by distillation under reduced pressure. The resulting polyamine was converted into the corresponding isocyanate with phosgene analogously to Example 1. The extinction at 430 nm according to the method described in Example 1 was 0.172 relative to chlorobenzene.

### Example 3 (According to the Invention)

An acid condensation mixture was prepared according to the procedure described in Example 1 from 838 g of aniline, 420 g of a 32% aqueous formaldehyde solution and 256 g of 32% hydrochloric acid. To 222 g of the resulting acid condensation mixture, were added 66 g of 32% aqueous sodium hydroxide solution and 95 g of ethanol, and stirring was carried out for 30 minutes at 105° C. After cooling to 60° C., 700 ml of water were added to the reaction mixture and, after phase separation as described in Example 1, the organic phase was washed with water and freed of aniline by distillation under reduced pressure. The resulting polyamine was converted into the corresponding isocyanate with phosgene analogously to Example 1. The extinction at 430 nm according to the method described in Example 1 was 0.164 relative to chlorobenzene.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the preparation of polyamines of the diphenylmethane series, comprising
a) reacting aniline and formaldehyde in the presence of an acid catalyst to form polyamines, and
b) neutralizing the reaction mixture with a base,
wherein at least one alcohol is present during and/or after the neutralization step, with the molar ratio of said alcohol to said formaldehyde being at least 0.02:1.

2. The process of claim 1, wherein the neutralization of the reaction mixture occurs in the presence of said alcohol.

3. The process of claim 2, wherein said alcohol is added at a point prior to neutralization.

4. The process of claim 3, wherein said alcohol is introduced with at least one of the starting reactants.

5. The process of claim 3, wherein said alcohol is directly added to the acid catalyzed reaction of aniline and formaldehyde.

6. The process of claim 2, wherein said alcohol is added during the neutralization of the reaction mixture.

7. The process of claim 1, wherein said alcohol is added after neutralization of the reaction.

8. The process of claim 1, additionally comprising
c) phase separating the neutralized reaction mixture, and
d) adding said alcohol and an additional quantity of a base to the organic phase.

9. The process of claim 1, wherein the said base comprises an aqueous sodium hydroxide solution.

10. The process of claim 1, wherein said alcohol is selected from the group consisting of: methanol, ethanol, n-propanol, isopropanol, monoethanolamine, N-substituted derivatives of monoethanolamine, diethanolamine, N-substituted derivatives of diethanolamine, triethanolamine, and mixtures thereof.

11. A process for the preparation of polyisocyanates of the diphenylmethane series comprising
a) reacting aniline and formaldehyde in the presence of an acid catalyst to form polyamines,
b) neutralizing the reaction mixture with a base, and
c) phosgenating the resultant polyamines into the corresponding polyisocyanates,
wherein at least one alcohol is present during and/or after the neutralization step with the molar ratio of said alcohol to said formaldehyde being at least 0.02:1.

12. The process of claim 11, wherein the neutralization of the reaction mixture occurs in the presence of said alcohol.

13. The process of claim 12, wherein said alcohol is added at a point prior to neutralization.

14. The process of claim 13, wherein said alcohol is introduced with at least one of the starting reactants.

15. The process of claim 13, wherein said alcohol is directly added to the acid catalyzed reaction of aniline and formaldehyde.

16. The process of claim 12, wherein said alcohol is added during the neutralization of the reaction mixture.

17. The process of claim 11, wherein said alcohol is added after neutralization of the reaction mixture.

18. The process of claim 11, additionally comprising:
d) phase separating the neutralized reaction mixture, and
e) adding said alcohol and an additional quantity of a base to the organic phase, prior to said phosgenation.

19. The process of claim 11, wherein said base comprises an aqueous sodium hydroxide solution.

20. The process of claim 11, wherein said alcohol is selected from the group consisting of: methanol, ethanol, n-propanol, isopropanol, monoethanolamine, N-substituted derivatives of mono ethanolamine, diethanolamine, N-substituted derivatives of diethanolamine, triethanolamine, and mixtures thereof.
